(19) United States
(12) Patent Application Publication
(10) Pub. No.: US 2024/0152751 A1
(43) Pub. Date: May 9, 2024

(54) MASSIVELY SCALABLE VR PLATFORM FOR SYNTHETIC DATA GENERATION FOR AI PILOTS FOR AIR MOBILITY AND CARS

(71) Applicant: Diana Deca, Dubai (AE)

(72) Inventor: Diana Deca, Dubai (AE)

(21) Appl. No.: 18/295,442

(22) Filed: Apr. 4, 2023

Related U.S. Application Data
(60) Provisional application No. 63/382,897, filed on Nov. 9, 2022.

(51) Int. Cl. G06N 3/08; A63F 13/60; G05D 1/00

(52) U.S. Cl. CPC G06N 3/08; A63F 13/60; G05D 1/0088

(57) ABSTRACT

The present invention is a scalable VR game for generating synthetic data. The synthetic data includes RGB and XYZ images from digital twins of entire cities at up to 01-meter accuracy and are updated by Google Maps, synthetic sensor, pilot data (including both performance and haptics such as haptics, response time, button presses, heartbeat, skin conductance, pupil dilation, etc.), and weather data, to be used for SLAM (Simultaneous Location and Mapping) and regulatory approval of EVTOL (Electric Vertical Take-off and Landing Aircraft), autonomous cars and robots. The synthetic data is generated from collected RGB images during the game. The VR-based game is interfaced with a full-stack neuromorphic backend platform for generating a VR-based anatomically accurate NeuroSLAM algorithm. The present invention, VR based computing system solves regulatory bottlenecks for fully autonomous Electric Vertical Take-off and Landing Aircraft (EVTOLs) and cars by providing hundreds of thousands of hours of training data without expensive and dangerous real-life tests. This synthetic data complement real-life tests for autonomous vehicles and brings them faster into regulatory approval, investment, and pre-orders from governments.

### CROSS-REFERENCE TO RELATED APPLICATIONS

This application claims the benefit of U.S. Provisional Application No. 63/382,897, titled “MASSIVELY SCALABLE VR PLATFORM FOR SYNTHETIC DATA GENERATION FOR AI PILOTS FOR AIR MOBILITY AND CARS” and filed on 2022 Nov. 9, the content of which is expressly incorporated herein by reference in its entirety. which is incorporated herein by reference.

### BACKGROUND

Data management systems need to efficiently manage and generate synthetic time-series data that appear realistic (i.e., appears to be actual data). Synthetic data includes, for example, anonymized actual data or fake data. Synthetic data is used in a wide variety of fields and systems, including public health systems, financial systems, environmental monitoring systems, product development systems, and other systems. Synthetic data may be needed where actual data reflecting real-world conditions, events, and/or measurements are unavailable or where confidentiality is required. Synthetic data may be used in methods of data compression to create or recreate a realistic, large-scale data set from a smaller, compressed dataset (e.g., as in image or video compression). Synthetic data may be desirable or needed for multidimensional datasets (e.g., data with more than three dimensions).

Data-driven algorithms have surpassed traditional techniques in every domain. Acquiring massive amounts of high-quality labeled training data is a tedious process. Generating quality data, collecting enough data, enlisting and training a labeling team, ensuring the labels are clean and consistent, and ensuring it adequately represents the breadth of situations the models may encounter in the real world and the like, requires a lot of time and effort.

Gathering and annotating that sheer amount of data in the real world is a time-consuming and error-prone task. The aforementioned problems limit scale and quality. Synthetic data generation has become increasingly popular since it is faster to generate and automatic to annotate. However, most of the current datasets and environments lack realism, interactions, and details from the real world.

Conventional systems and methods may be limited to generating synthetic data within an observed range of parameters of actual data (e.g., a series of actual minimum and maximum values), rather than modeled synthetic parameters (e.g., a series of synthetic minimum and maximum values). Some approaches may use pre-defined data distributions to generate synthetic data, an approach that may require human judgment to choose a data distribution rather than using machine learning to choose a distribution to generate synthetic data. Some approaches may be limited to generating time-series data in just one direction (e.g., forward in time). Some approaches may be limited to generating data within a limited time scale (e.g., hours, weeks, days, years, etc.) and may not be robust across time scales.

Further, the advancements in technology have led to the invention of Electric Vertical Take-off and Landing Aircraft (EVTOLs), autonomous cars, and robots. However, training fully autonomous Electric Vertical Take-off and Landing Aircraft (EVTOLs) without expensive real-life tests is a challenge yet to resolve. Training of EVTOLs requires gathering and annotating accurate, sheer amounts of data which is a time-consuming and error-prone task.

Two existing systems, UnrealROX and Unity reduced that reality gap by leveraging hyperrealistic indoor scenes that are explored by robot agents which also interact with objects in a visually realistic manner in the simulated world. Photorealistic scenes and robots are rendered by Unreal Engine into a virtual reality headset that captures the gaze such that a human operator can move the robot and use controllers for the robotic hands. However, systems do not have applications into SLAM (Simultaneous Location and Mapping) and regulatory approval of EVTOL (Electric Vertical Take-off and Landing Aircraft) and autonomous cars, and a massively scalable VR platform that can generate high-quality data for spatial computing has not yet been invented.

Another existing system, NVIDIA generates synthetic data through scalable virtual reality (VR). However, this conventional system is incapable of generating pilot data such as trajectory data, coordinates of a vehicle, vehicle velocity, take-off/landing data, and eye tracking data. Additionally, the data generated by this conventional system does not have applications in EVTOL (Electric Vertical Take-off and Landing Aircraft), autonomous cars, and robots.

Most importantly, neither NVIDIA, Microsoft, or others have generated such a massively scalable VR environment to send synthetic training data in real-time in a manner that is relevant for the air mobility field. Neurobotx works with NASA decision-makers from its board to make sure the data generated is indeed helpful for expediting the regulatory process for EVTOL certification for massive scaling across cities. Furthermore, several major EVTOL companies have agreed to purchase such data via an official paid partnership with Neurobotc, thereby confirming the need for acquiring such data not only for the regulatory process for EVTOL certification but also for training their own AI pilots, expected to start at level 4 autonomy.

Hence, there is a need for a system to efficiently generate synthetic data through scalable virtual reality (VR) gaming to train SLAM (Simultaneous Location and Mapping) algorithms thereby enabling the regulatory approval of fully autonomous EVTOL (Electric Vertical Take-off and Landing Aircraft), autonomous cars and robots.

According to a recent NASA study on the acceptance of EVTOL-based urban air mobility, more than 75% of respondents admitted to not knowing what EVTOLs are, therefore showing the urgent need for methods like gaming for improving public acceptance of such vehicles before they scale.

### SUMMARY

This summary is provided to introduce a selection of concepts, in a simple manner, which is further described in the detailed description of the disclosure. This summary is neither intended to identify essential inventive concepts of the subject matter nor to determine the scope of the disclosure.

Embodiments of a present disclosure relate to scalable virtual reality (VR) systems and more particularly to a system and a method to generate synthetic data from VR gaming to obtain VR-based anatomically accurate NeuroSLAM (brain-inspired simultaneous localization and mapping algorithm) for autonomous vehicles.

The current Embodiment is based on the technology that is cloud-based Artificial Intelligence (AI). It enables building optimal, customized AI models from scratch and training them in Virtual Reality. It further shall generate Synthetic Data for the provision of balanced datasets for any Computer Vision applications like object detection & recognition, 3D positioning, pose estimation, and other sophisticated cases including analysis of multi-sensor data that can be used by AI Pilots for ground vehicles and air mobility.

In accordance with another embodiment, a method to efficiently generate synthetic data through scalable virtual reality (VR) gaming is disclosed. The synthetic thus obtained is utilized to train SLAM (Simultaneous Location and Mapping) algorithms, thereby enabling the regulatory approval of fully autonomous EVTOL (Electric Vertical Take-off and Landing Aircraft), autonomous cars, and robots. The method provides a scalable virtual reality game. This scalable VR game is used to collect data from red, green blue (RGB) images. An RGB image, sometimes referred to as a true color image, is stored as an m-by-n-by-3 data array that defines red, green, and blue color components for each pixel. The RGB images do not use a palette. The data collected from RGB images further facilitates the generation of synthetic data. Synthetic data is data generated artificially rather than generated by real-life events. In the present invention, the synthetic data includes sensor data (infrared, RGB, neuromorphic, depth sensor), weather data (different wind and visibility conditions), information about trajectory, XYZ coordinates of a vehicle, velocity, take off, landing, and overall pilot performance information combined with haptics which includes eye tracking, button presses, reaction time, etc. The synthetic data thus obtained is stored in a storage unit. The storage unit further facilitates the training of data-driven algorithms such as SLAM (Simultaneous Location and Mapping), thereby enabling regulatory approval of EVTOL (Electric Vertical Take-off and Landing Aircraft), autonomous cars, and robots. Importantly, the system allows for SLAM training of AI pilots using a unique combination of events, such for example a simulated storm, night vision, incoming obstacles, and so forth.

According to an aspect of some embodiments of the present disclosure, the current invention is a virtual reality-based game with the capability of handling a plurality of motor assemblies, thrust created by the movement of air, a respective axis of the thrust of the motor assembly; wings; and locomotive movement of vehicles. It provides an advanced level of synthetic data generation for generating Algorithms, which further can be used by AI Pilots for Air and land movement vehicles with maximum accuracy.

Importantly, the VR game incorporates large simulations of entire cities and aims to have most major cities mapped in the near term. Currently, these simulations have up to 1 m accuracy, custom made rendering for increased realism. Thus, dozens of real flights can be combined with thousands of simulated flights with Google Maps-level accuracy for expedited regulatory approval.

The present invention solves regulatory bottlenecks for fully autonomous Electric Vertical Take-off and Landing Aircraft (EVTOLs) and autonomous cars by providing hundreds of thousands of hours of training data without expensive and dangerous real-life tests. This synthetic training data complement real-life tests for autonomous vehicles and brings them faster into the regulatory approval, investment, and pre-orders from governments.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating an exemplary computing environment for generating synthetic data through a scalable virtual reality (VR) game, following an embodiment of the present disclosure; —Replace ‘neuromorphic’ with AI platform in all sketches.

FIG. 2 is a block diagram illustrating an exemplary full-stack AI platform, such as those shown in FIG. 1, for generating synthetic data through a scalable virtual reality (VR) game, following an embodiment of the present disclosure; and

FIG. 3 is a block diagram illustrating an exemplary method for generating synthetic data through a scalable virtual reality (VR) game thereby applying the data to train an exemplary EVTOL module—Metapilot, following an embodiment of the present disclosure.

Further, those skilled in the art will appreciate those elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

To promote an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

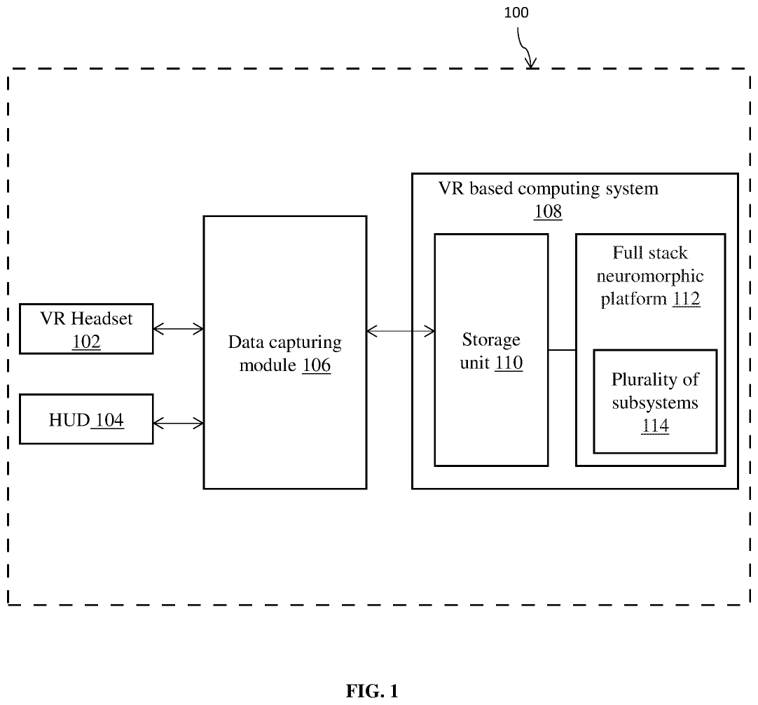

Referring now to the drawings, and more particularly to FIG. 1 through FIG. 3, where similar reference characters denote corresponding features consistently throughout the figures, there are shown preferred embodiments and these embodiments are described in the context of the following exemplary system and/or method.

FIG. 1 is a block diagram illustrating an exemplary computing environment 100 for generating synthetic data through a scalable virtual reality (VR) game, with an embodiment of the present disclosure. FIG. 1 depicts the exemplary computing environment 100 that enables the generation of synthetic data which is then used to train several data-driven algorithms. The exemplary computing environment 100 comprises a VR headset 102, a Heads-up display (HUD) 104, a data capturing module 106, and a VR-based computing system 108. The VR-based computing system 108 comprises a storage unit 110 and a full-stack neuromorphic platform 112. The full-stack neuromorphic platform 112 comprises a plurality of modules 114. The VR headset 102 is a head-worn device that covers the eyes and takes a user into a virtual environment. The VR headset 102 (also known as VR goggles) provides an immersive experience to viewers or users by taking them to a virtual environment. Different combinations of head and eye trackers are also part of many such headsets. The VR headset 102 tracks the movement of users and copies them into a virtual world. All these factors in combination make the virtual experience more immersive while gaming. Another user interface (UI) component is the Heads-up display (HUD) 104. In video gaming, the HUD (heads-up display) 104 or status bar is a method by which information is visually relayed to a player (or the user) as part of a game's user interface. The HUD 104 takes its name from the head-up displays used in modern aircraft. The HUD 104 is frequently used to simultaneously display several pieces of information. The information includes updates about various characters in the game and their respective health, items, an indication of game progression (such as score or level), and the like. The VR headset 102 and the HUD 104 assist the user to play the VR-based scalable game.

The data capturing module 106 is used to extract synthetic data from the computing environment 100. The data capturing module 106 is configured to automatically extract and generate synthetic data from a VR game played via the VR headset 102 and/or the HUD 104. The synthetic data includes sensor data (infrared, RGB, neuromorphic, depth sensor), weather data (different wind and visibility conditions), information about trajectory, XYZ coordinates of a vehicle, velocity, take off, landing, and overall pilot performance—including eye tracking.

The VR-based computing system 108 comprises a storage unit 110 and a full-stack neuromorphic platform 112. Storage unit 110 stores all the virtual data extracted from the data capturing module 106. The VR-based computing system 108 also consists of a full-stack neuromorphic platform 112 which further includes a plurality of subsystems 114. The full stack neuromorphic platform 112 is the first neural network platform for autonomous navigation based on research in the 2×Nobel lab that discovered a brain's navigation system. The present invention aims at rebuilding the brain navigation system that is up to 1000×faster and 10,000× more energy efficient to process the millions of hours of virtual data of autonomous navigation scenarios that would otherwise be unobtainable (for instance, accidents, unlikely events, bad weather conditions and the like).

Those of ordinary skilled in the art will appreciate that the hardware depicted in FIG. 1 may vary for particular implementations. For example, other peripheral devices such as Local Area Networks (LAN), Wide Area Networks (WAN), Wireless (e.g., Wi-Fi) adapters, graphics adapters, disk controller, input/output (I/O) adapters also may be used in addition or place of the hardware depicted. The depicted example is provided for explanation only and is not meant to imply architectural limitations concerning the present disclosure.

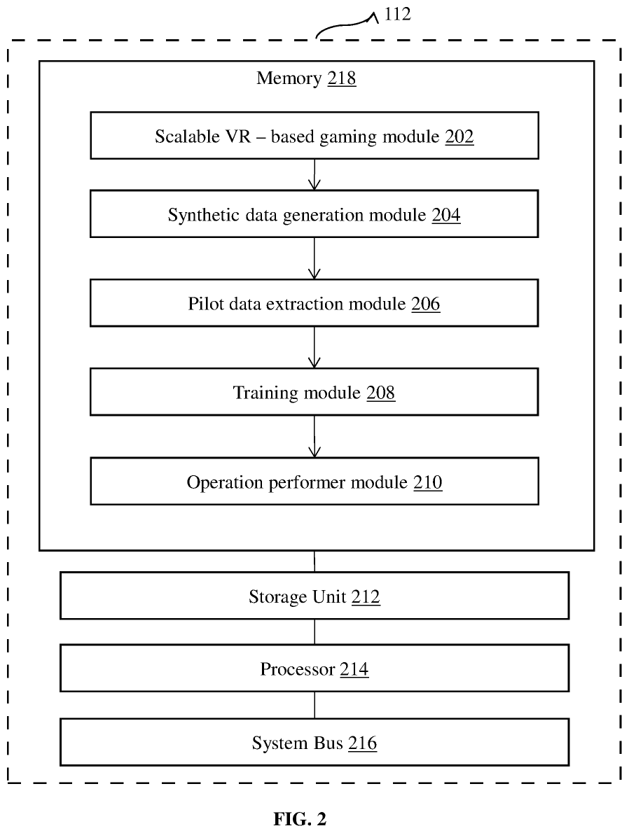

FIG. 2 is a block diagram illustrating an exemplary full-stack neuromorphic platform 112, such as those shown in FIG. 1, for enabling the generation and application of synthetic data to train SLAM, fully automated EVTOLs, autonomous cars, and robots in an embodiment of the present disclosure; The full stack neuromorphic platform 112 comprises a memory 218. Memory 218 comprises a scalable VR-based gaming module 202, a synthetic data generation module 204, a pilot data extraction module 206, a training module 208, an operation performer module 210, and the like.

In an embodiment of the present disclosure, the processor(s) 214, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

In another embodiment of the present disclosure, memory 218 includes the plurality of modules 114, stored in the form of an executable program that instructs the processor 214 via a system bus 216 to perform the method steps illustrated in FIG. 2.

The scalable VR-based gaming module 202 interacts with a user via the VR headset 102 or HUD 104. Further, the scalable VR-based gaming module 202 automatically generates an enormous amount of synthetic data based on the user's performance during the VR-based game.

The synthetic data generation module 204 extracts synthetic data from RGB images. The RGB images are captured during the scalable VR-based game and are generated by the data capturing module 106. Further, the RGB images are stored in storage unit 110. The synthetic data thus obtained is information that is artificially generated rather than produced by real-world events. In the present invention, the data generated by the scalable VR-based game using RGB images is the synthetic data. The present invention uses unity or unreal game engine generated data, and from the RGB images sent into the storage unit 110, the present invention simulates depth and infrared sensors, XYZ coordinates, pilot performance, take off, landing, neuromorphic/event sensor data, and simulated weather conditions data. Eventually, the present invention aims at adding haptics such as eye tracking, button presses, reaction times, and the like to the synthetic data generated. The output of such systems approximates real-time data, nevertheless, the synthetic data is completely algorithmically generated. In the present invention, the synthetic data generated by the synthetic data generation module 204 includes sensor data (infrared, RGB, neuromorphic, depth sensor), weather data (different wind and visibility conditions), information about trajectory, XYZ coordinates of vehicle, velocity, take-off, landing, and overall pilot performance—including eye tracking.

The pilot data extraction module 206 is configured to retrieve relevant pilot data from the synthetic data generated. This pilot data which is accurate and relevant is then passed on to training module 208.

The training module 208 is configured to train various data-driven algorithms. The present invention focuses on training SLAM, regulatory approval of EVTOL, autonomous cars, and robots The present invention solves the regulatory bottleneck for fully autonomous EVTOLs and cars by providing hundreds of thousands of hours of training data without the expensive and dangerous real-life tests.

Finally, the operation performer module 210 is configured to perform one or more operations based on the trained data-driven algorithms. The VR-based game is interfaced with a full-stack neuromorphic platform 112. With the assistance of the synthetic data generated, the full-stack neuromorphic platform 112 trains the VR-based anatomically accurate NeuroSLAM algorithm that enables the generation of AI pilot data. The AI pilot data enables the operation of fully autonomous EVTOLs. The present invention uses a full stack neuromorphic platform 112 to process the virtual data, train the aforementioned algorithms, such as NeuroSLAM and finally generate an AI pilot or Metapilot. The AI pilot or Metapilot enables the functioning of fully autonomous EVTOLs, autonomous cars, and robots. Additionally, the full stack neuromorphic platform 112 used to implement AI pilot is the first neural network for autonomous navigation based on the research in 2×Nobel lab that discovered the brain's navigation system. The present invention rebuilds the brains navigation system that is up to 1000× faster and 10,000× more energy efficient to process the millions of hours of data of autonomous navigation scenarios that would otherwise be unobtainable (such as accidents, unlikely events, bad weather conditions, and the like).

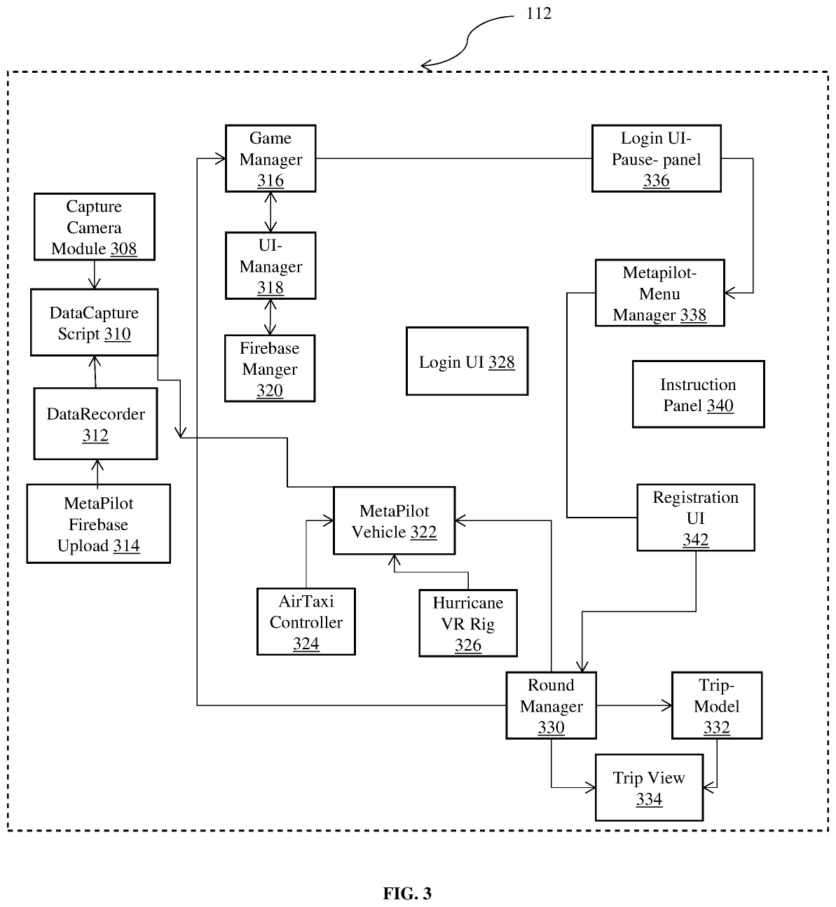

FIG. 3 is a block diagram illustrating an exemplary method 300 for generating synthetic data through a scalable virtual reality (VR) game, thereby applying the synthetic data to train an exemplary SLAM, EVTOL, autonomous cars, and robots, following an embodiment of the present disclosure. FIG. 3 is explained in culmination with the following modules.

In an embodiment of the present disclosure, the game manager 316 is responsible for a VR-based game flow. The game manager is further associated with a firebase manager 320, a MetaPilot menu manager 338, a UI manager 318, and a round manager 330. The firebase manager 320 controls all interactions with a firebase. Firebase is a backend application development software that enables developers to develop iOS, android, web platforms, applications, and the like. The firebase manager 320 controls login UI elements and register UI elements. The login UI elements and register UI elements are responsible for registering a user to the full stack neuromorphic platform 112 and logging in the user into the application whenever required. The MetaPilot menu manager 338 controls an in-game UI and an out-game UI. Further, the MetaPilot menu manager 338 is associated with a login canvas, an instruction panel 340, a login UI 328, a pause panel 336, and a registration UI 342. The login UI 328 controls the ingame and out-game UI. The login UI 328 further controls the login canvas, instruction panel 340, pause panel 336, and registration UI 342. Furthermore, the instruction panel 340 performs the same functionality as the login UI 328. The MetaPilot menu manager 338 is further connected to the round manager 330 through registration UI 342. The round manager 330 is responsible for controlling the switching of trips for one complete round. The trips in the present disclosure refer to a ride in the autonomous EVTOLs, air taxi, and the like. Registration UI 342 is responsible for controlling the in-game UI and out game UI. The registration UI 342 further controls the login canvas, the instruction panel 340, the login UI 328, the pause panel 336, and the registration UI 342. The round manager 330 is further connected to two subsystems—a trip view 334 and a trip model 332. Trip view 334 is a unity class of trip that handles a trip start and a trip end position. The trip views 334 further control arrival pin location, destination pin along with passenger details. The functions of the trip view 334 include PlayerAnived( ), PlayerArrivedInVehicle( ), and OnDestroy( ). Trip view 334 is further connected to trip model 332. The trip model 332 is responsible for controlling the business logic of the trip. The trip model 332 further manages the trip time, time passed, collected points, fare, rank, drive points, and stunts. On scheduling a trip, the Round manager 330 is connected to a MetaPilot vehicle 332. The MetaPilot vehicle 332 is the script that controls all the functionality of the vehicle related to the application. Further, the MetaPilot vehicle 332 controls the hurricane VR Rig 326 and the air taxi controller 324, along with the passenger place left door, right door, collision detector, non-VR camera, default camera, and Cut scene camera. The MetaPilot vehicle 332 includes the functions SetMode( )(PC/VR), SetDefaultOrientation( )(ThirdPerson/First), FreezeUnfreeezeInput( ) CollisionDetection( ) and the like. The air taxi controller 324 connected to the MetaPilot vehicle 332 is the main component of the taxi controller from the salaintro plugin. The MetaPilot Vehicle 332 is responsible to control all the fly mechanics and generate data such as fore, moment, throttle, pitch, roll, yaw, and the like. Further, the hurricane VR Rig 326 connected to MetaPilot Vehicle 332 is responsible to control the VR functionality and is the script of the Hurricane VR plugin. Furthermore, the MetaPilot Vehicle 332 is connected to a Data capture script 310. The data capture script 310 is a component on the camera whose RGB images are recorded. It is originally considered to be the script of AirSim, with AirSim now disintegrated. The data capture script 310 is connected to MetaPilot vehicle 332 and the camera filter. The data capture script 310 includes the functions GetFrameData( ), CaptureFrame( ), ConvertToPNG( ), SetupCamera( ), SetupRenderType( ) and ToggleRcording( ). The data recorder 312 connected to the MetaPilot vehicle 332 is a singleton script that records data to a local server. Further, the data recorder 312 is controlled Image data (data which is recorded). Furthermore, the data recorder 312 includes the functions StartRecording( ), StopRecording( ), AddImageDataToQueue( ), and SaveImageThread( ). The MetaPilot firebase upload 314 is further connected to the data recorder 312. The MetaPilot firebase upload 314 is a file responsible for uploading data on firebase. The MetaPilot firebase upload 314 is mainly a storage reference. The MetaPilot firebase upload 314 includes functions such as UploadFile( ) and UploadBytes( ).

All the aforementioned subsystems collectively help generate synthetic data from a VR-based scalable game and utilize the same virtual data for training and functioning of a fully autonomous AI pilot or MetaPilot. The fully autonomous AI pilot or MetaPilot is a VR-based computing system 108 as mentioned in FIG. 1. The fully autonomous AI pilot or MetaPilot further enables the training and smooth functioning of fully autonomous AirTaxi.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and is not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

What is claimed is:

1. A system for scalable VR system capable of generating synthetic data for AI Pilots for Air Mobility and cars, comprising:
one or more memory units storing instructions; and one or more processors that execute the instructions to perform operations; receiving a dataset comprising time-series data; generating a dataset of synthetic data comprising: weather data, aircraft model data from multiple partners across the airtaxi, aerospace and mobility industries, simulated accidents data including crashes, pedestrians, animals etc., neuromorphic camera data, other sensor data including but not limited to infrared data, lidar data, sonar data, and other emerging sensor data to be generated together with relevant industry partners, haptics data from pilots including eye tracking, stress levels, movement data and such correlated datasets to be decided together with industry partners in aerospace and mobility, as well as together with regulatory bodies in aerospace and mobility, generating a plurality of data segments based on the dataset; determining respective segment parameters of the data segments; determining respective distribution measures of the data segments; training a parameter model to generate synthetic segment-parameters, the training is based on the segment parameters; training a distribution model to generate synthetic data-segments, the training is based on the distribution measures and the segment parameters; generating a synthetic dataset using the parameter model and the distribution model; and storing the synthetic dataset.

2. The system of claim 1, wherein generating a synthetic dataset comprises:
generating synthetic data via the parameter model and using RGB codes and point on a series of synthetic segment parameters; and generating, via the distribution model, a series of synthetic data segments based on the series of synthetic segment parameters;

3. The system of claim 1, wherein:
the operations further comprise generating the parameter model; the gaming model leading to training the parameter model is based on generating the parameter model.

4. The system of claim 1, wherein:
the operations further comprise generating the distribution model and training the distribution model based on generating the distribution model.

5. The system of claim 1, wherein generating data segments is based on a predetermined segment size and points accurately up to 1 meter.

6. The system of claim 1, wherein generating data segments comprises determining a segment size based on a statistical measure of the dataset and enabling the user to ride in the autonomous EVTOLs, air-taxi, and the like.

7. The system of claim 1, wherein the segment parameters comprise a minimum value, a maximum value, a start value, and an end value allows the user to control the hurricane and have an air taxi controller along with passenger place doors embedded with a collision detector, non-VR camera, default camera in a virtual setting.

8. The system of claim 1, wherein the distribution measures include at least one variance, a standard deviation, or a regression result of a time-dependent function and provides a full-stack neuromorphic platform.

9. The system of claim 1, wherein the distribution model comprises a multilayer perceptron model, a convolutional neural network model, or a sequence-to-sequence model

10. The system of claim 1, wherein training the distribution model comprises:
training the distribution model to generate synthetic segment data; determining synthetic distribution measures of the synthetic data segments; determining a performance metric based on the distribution measures and the synthetic distribution measures; and terminating training of the distribution model based on the performance metric satisfying a criterion.

11. The system of claim 1, is a VR-based anatomically accurate NeuroSLAM algorithm that enables the generation of AI pilot data for air mobility and cars.

12. The system of claim 1, the operations further comprising:
generating a data profile of the dataset, and storing the distribution model in a data index based on the data profile.

13. The system of claim 1, wherein:
the dataset comprises multidimensional time-series data; the data segments comprise multidimensional data segments which are RGB readable; and the segment parameters comprise multidimensional segment parameters.

14. The system of claim 1, wherein:
receiving the dataset comprises receiving the dataset from a client device, and the operations further comprise transmitting the synthetic dataset through system-on-a-chip is further characterized by at least one memory device interface structured to connect the system-on-a-chip to at least one memory device storing instructions that when executed by system-on-the-chip, enables the system-on-a-chip to operate as an autonomous vehicle controller.

15. The system of claim 1, wherein receiving the dataset comprises receiving the dataset at a cloud service.

16. A system for generating synthetic data, comprising:
one or more memory units storing instructions; and one or more processors that execute the instructions to perform operations comprising: receiving a dataset comprising time-series data; generating a data profile of the dataset; generating a plurality of data segments based on the dataset; determining respective segment-parameters of the data segments, the segment parameters comprising a minimum value, a maximum value, a start value, and an end value; determining respective distribution measures of the data segments; generating a parameter model based on the dataset; training the parameter model to generate synthetic segment-parameters, the training being based on the segment parameters; generating a distribution model based on the dataset; training the distribution model to generate synthetic data-segments, the training being based on the distribution measures and the segment parameters; generating a synthetic dataset by: generating, via the parameter model, a series of synthetic segment-parameters; and generating, via the distribution model, a series of synthetic data-segments based on the series of synthetic segment-parameters; storing the synthetic dataset; and storing the parameter model and the distribution model in a data index based on the data profile.
